(19) United States
(12) Patent Application Publication
(10) Pub. No.: US 2026/0146637 A1
(43) Pub. Date: May 28, 2026

(54) SHEET METAL WITH PUNCHED STRUCTURES FOR CONNECTING TWO WOODEN ELEMENTS, COMPOSITE OF TWO WOODEN ELEMENTS WITH THE SHEET METAL AND METHOD FOR PRODUCING THE SHEET METAL

(71) Applicant: Adolf Würth GmbH & Co. KG, Künzelsau (DE)

(72) Inventors: Johannes Sänger, Karlsruhe (DE); Raphael Fakler, Karlsruhe (DE); Sebastian Zimprich, Karlsruhe (DE); Arne Barz, Ilshofen (DE); Fabienne Kellermann, Crailsheim (DE); Markus Döllken, Karlsruhe (DE); Sven Matthiesen, Karlsruhe (DE)

(21) Appl. No.: 19/340,437

(22) Filed: Sep. 25, 2025

(30) Foreign Application Priority Data
Sep. 26, 2024 (DE) 10 2024 127 967.2

(51) Int. Cl. F16B 15/00; B21D 28/26

(52) U.S. Cl. CPC F16B 15/0046; B21D 28/26; F16B 2015/0069

(57) ABSTRACT

The present disclosure relates to a sheet metal for joining two wooden elements, the sheet metal having punched structures each having a hole with a diameter of less than 5 mm, preferably less than 3.5 mm, more preferably less than 2.5 mm, and four teeth projecting from a main surface of the sheet metal distributed around a circumference of the hole. The punched structures are provided on both main surfaces of the sheet metal. At least in the majority of the punched structures, preferably in all punched structures, all teeth of a respective punched structure project from the same main surface of the sheet metal. A number of the punched structures on the one main surface is at least 90%, preferably 100%, of a number of the punched structures on the other main surface.

### CROSS-REFERENCE TO RELATED APPLICATION

This application claims priority of the German patent application DE 10 2024 127 967.2 filed on Sep. 26, 2024, which is incorporated by reference herein in its entirety.

### FIELD OF DISCLOSURE

The disclosure relates to a sheet metal with punched structures for connecting two wooden elements, as well as a composite of two wooden elements with the sheet metal arranged in between and a method for producing the sheet metal.

### ART BACKGROUND

It is known to connect wooden beams with butt joints to one another by a shear or tension/shear joint. In this case, for example, one end of a beam is placed at a 0 to 90° angle on another beam and fastened there with screws or other pin-shaped connecting means. The screws can be screwed through both or a plurality of beams at an angle, in particular at a 90° angle from the side opposite a beam.

Furthermore, it is known to fasten wooden beams to a concrete wall or to a metal plate, for example a wooden connector. For this purpose, for example, screws or pin-shaped connecting means are screwed through the wood and then into the concrete wall or into the metal plate.

In the case of wood-wood joints, high rigidity is achieved in particular by a glued joint. This requires special application environments. Other wood-wood connectors hardly currently achieve the rigidity values of the joint.

WO 2022/090281 A1 discloses a method for connecting at least two wooden building boards for sound insulation and/or thermal insulation. A metal plate or a metal strip with teeth that face in the direction of the surface of the at least one wooden board is arranged in a direction substantially perpendicular to the surface of the metal plate or the metal strip, an insulating element with teeth is attached to the second surface of the wooden building board, a second metal plate or a metal strip is attached to the insulating element, a third element of a wooden building board with teeth is attached to the second surface of the second metal plate or the metal strip, and screws are inserted through at least one element and at least one plate, wherein the screws pierce the metal plate or the metal strip during insertion.

US 2017/0073972 A1 discloses a composite assembly with a series of elongated layers that are connected to one another longitudinally. At least two of the elongated layers each have an upper elongated portion and a lower elongated portion that are connected to one another end-to-end by a connection arrangement at an intermediate connection point. The upper elongated portion consists of a wood material and the lower elongated portion consists of a material other than wood. The lower elongated portion can contain a reinforcement bar.

All the listed solutions achieve only lower rigidity in the composite. In addition, it is disadvantageous in the case of conventional wood joints that the loads that hold the joints are too low, such that higher bearing loads or higher rigidities are desired.

There is a need to provide a sheet metal for connecting two wooden elements that achieves higher rigidity values and higher bearing loads of the wood-wood joint. This need is met by the sheet metal having the features of claim 1. Advantageous developments are defined in the dependent claims.

### SUMMARY OF THE DISCLOSURE

According to a first aspect of the present disclosure, a sheet metal for connecting two wooden elements is provided. The sheet metal has punched structures each having a hole with a diameter of less than 5 mm, preferably less than 3.5 mm, more preferably less than 2.5 mm, and four teeth projecting from a main surface of the sheet metal distributed around a circumference of the hole. The punched structures are provided on both main surfaces of the sheet metal, and at least in the majority of the punched structures, preferably in all punched structures, all teeth of a respective punched structure project from the same main surface of the sheet metal. A number of the punched structures on the one main surface is at least 90%, preferably 100%, of a number of the punched structures on the other main surface.

In the context of the present disclosure, the term “main surface of the sheet metal” can denote the largest area of the sheet metal. The sheet metal has substantially the shape of a hexahedron, wherein two opposite areas of the hexahedron, which can be referred to as main surfaces, are significantly larger than the intermediate lateral surfaces.

The sheet metal can be made of a metal, in particular steel, for example an unalloyed steel or stainless steel, or aluminum.

At a connection point, the two wood elements bear against one another, wherein the sheet metal is arranged between them. Preferably, the two wood elements bear against the sheet metal over the full area at the connection point. However, it is possible that portions of the wood elements bear directly against one another. The wood joint produced at the connection point between the two wood elements and the sheet metal is held together by fastening elements, in particular wood screws. The fastening elements thus press the wood elements against the sheet metal with a certain contact pressure. The teeth are pressed into the wood, such that the teeth hook in the wood fibres and a predominantly force-fitting connection is established between the sheet metal and the respective wood elements. The force fit counteracts a displacement of the wood elements relative to one another, i.e. the initial displacement of the wood elements relative to one another is made more difficult. A relative displacement of the wood elements relative to one another thus takes place only in the case of a very greatly increased shearing force in comparison with a wood joint without sheet metal. The addition of the sheet metal virtually activates the friction in the wood-wood joint, which increases the rigidity of the entire joint.

The present disclosure provides, with the sheet metal, a planar connecting means that has a reduced press-in force in comparison with the prior art and can nevertheless transmit high shearing forces.

According to one exemplary embodiment, a sheet metal thickness is less than 0.5 mm. Such a small sheet metal thickness (<0.5 mm) enables simplified packaging, transport and handling of the sheet metal and application of the sheet metal without an air gap between the two wooden elements that are connected.

According to one exemplary embodiment, the teeth each have a base line corresponding to an intersection of the respective tooth with the corresponding main surface of the sheet metal and at which the respective tooth projects from the corresponding main surface of the sheet metal, wherein an angle of the base line to an edge of the sheet metal, preferably a long edge of the sheet metal, is preferably between 30 and 60°, more preferably between 40 and 50°, particularly preferably substantially 45°. According to one exemplary embodiment, in the case of a curved base line, the angle is measured as a mean angle enclosed between the edge of the sheet metal and a line connecting end points of the base line. These tooth inclinations to the longitudinal side of the sheet metal result in each of the four teeth of such a rasp hole being loaded equally.

According to one exemplary embodiment, a total volume of all four teeth of a respective punched structure is less than 2.5 mm³. In this case, the teeth of the punched structures can engage effectively in the wood fibres and ensure particularly good rigidity and bearing load of the composite.

According to one exemplary embodiment, the teeth are curved such that a tooth tip of a respective tooth faces away from the hole, and wherein the tooth tips of adjacent teeth do not form a minimum distance between the adjacent teeth, such that, for example, the tooth tip of a tooth is curved or arched toward the side facing away from the hole, but does not project beyond the tooth root. The curvature or arching of the teeth achieves a particularly strong connection between the sheet metal and the wood elements. The curvature of the teeth can be achieved by adjusting a certain punch depth of a punch in the sheet metal. The punch ensures the formation of the punched structures. The punch preferably has a rectangular profile, more preferably a square profile, in cross section.

According to one exemplary embodiment, the teeth are curved and a distance between two adjacent teeth is greater than the diameter of the hole, such that an effective density of the punched structures is formed in the sheet metal.

According to one exemplary embodiment, the punched structures are arranged in each case in a matrix with rows and columns on both main surfaces of the sheet metal, wherein in each case adjacent rows are displaced from one another by half a hole spacing in the longitudinal direction of the rows and wherein in each case adjacent columns are displaced from one another by half a hole spacing in the longitudinal direction of the columns. The rows are preferably oriented perpendicularly to the columns.

According to one exemplary embodiment, the matrix has first rows with first punched structures, the teeth of which project from the one main surface of the sheet metal, and second rows with second punched structures, the teeth of which project from the other main surface of the sheet metal, wherein the first rows and the second rows are arranged adjacent to one another and alternately on both main surfaces of the sheet metal. The matrix-like arrangement of the teeth enables as direct as possible a conduction of force from one main surface of the sheet metal to the other main surface, and simple production of the sheet metal. The distances between adjacent rows and the distances between adjacent columns are preferably in each case constant.

According to one exemplary embodiment, an orientation of the rows and an orientation of the columns are substantially parallel to a respective edge of the sheet metal.

According to one exemplary embodiment, an orientation of the rows and an orientation of the columns run at respective angles to a respective edge of the sheet metal, wherein the angles lie in a range between 30 and 60°, preferably are each substantially 45°.

According to one exemplary embodiment, the punched structures of a row are arranged alternately on both main surfaces of the sheet metal, and/or the punched structures of a column are arranged alternately on both main surfaces of the sheet metal. In the two last-mentioned exemplary embodiments, a direct transmission of force between the teeth of adjacent columns is advantageously provided, such that, on account of this method of production, internal stresses can be minimized by a more uniform distribution and the production-related flatness of the sheet metal can be optimized.

According to one exemplary embodiment, the rows run parallel to a longer edge of the sheet metal and the columns run parallel to a shorter edge of the sheet metal.

According to one exemplary embodiment, the sheet metal is configured to be screwed through by a screw.

According to one exemplary embodiment, tooth tips of opposite teeth of a respective punched structure face in directions away from each other. The tooth curvature of the tooth tip toward the side facing away from the hole results in a significant increase in the rigidity in the composite.

According to one exemplary embodiment, a height of the teeth is 1.5 to 5 times, preferably 2 to 4 times, more preferably 2.5 to 3.5 times, greater than a thickness of the sheet metal, whereby a favorable equilibrium between tooth height and sheet metal thickness is achieved.

According to one exemplary embodiment, adjacent teeth of the same punched structure have a common overlap region extending vertically above the respective main surface of the sheet metal. According to one exemplary embodiment, the adjacent teeth of the same punched structure show a crown profile in a first side view. A crown profile can have a ring with a plurality of, at least three, placed-on prongs. According to one exemplary embodiment, the adjacent teeth of the same punched structure show a profile of two side-by-side, partially overlapping triangles or trapezoids in a second side view.

According to one exemplary embodiment, the sheet metal is strain hardened and the teeth are hardened so that they do not deform or only slightly.

According to one exemplary embodiment, a number of the punched structures per cm² is between 2 and 15, preferably between 3 and 10, more preferably between 5 and 8.

According to a second aspect of the present disclosure, composite of two wooden elements with the sheet metal arranged in between is provided. The sheet metal can be used as an addition in wood-wood joints for increasing rigidity, for example in ribbed ceilings.

According to a third aspect of the present disclosure, a method for producing a sheet metal for connecting two wooden elements is provided. The method has a step for punching the sheet metal with a punch so as to form punched structures each having a hole with a diameter of less than 5 mm, preferably less than 3.5 mm, more preferably less than 2.5 mm, and four teeth projecting from a main surface of the sheet metal distributed around a circumference of the hole. The punched structures are provided on both main surfaces of the sheet metal, and at least in the majority of the punched structures, preferably in all punched structures, all teeth of a respective punched structure project from the same main surface of the sheet metal. A number of the punched structures on the one main surface is at least 90%, preferably 100%, of a number of the punched structures on the other main surface.

According to one exemplary embodiment of the method, the punch has a rectangular or square profile. An edge length of the punch is preferably between 1 and 2.5 mm, more preferably between 1.2 and 1.6 mm.

According to one exemplary embodiment of the method, a defined curvature of the teeth is adjusted by using a certain punch depth of the punch. Exemplary embodiments of the present disclosure are described in detail below with reference to the following figures.

### BRIEF DESCRIPTION OF THE DRAWINGS

FIG. 1 shows a side view and a plan view of a sheet metal according to one exemplary embodiment of the present disclosure.

FIG. 2 shows an enlarged detail of the side view of FIG. 1.

FIG. 3 shows an enlarged detail of the side view and the plan view of FIG. 1.

FIG. 4 shows a side view of a punched structure from a direction A of FIG. 3.

FIG. 5 shows a side view of a punched structure from a direction B of FIG. 3.

FIG. 6 shows an exemplary application of a sheet metal according to one exemplary embodiment of the present disclosure.

FIG. 7 shows a side view and a plan view of a sheet metal according to one exemplary embodiment of the present disclosure.

### DETAILED DESCRIPTION

Identical or similar components in different figures are provided with identical reference numerals.

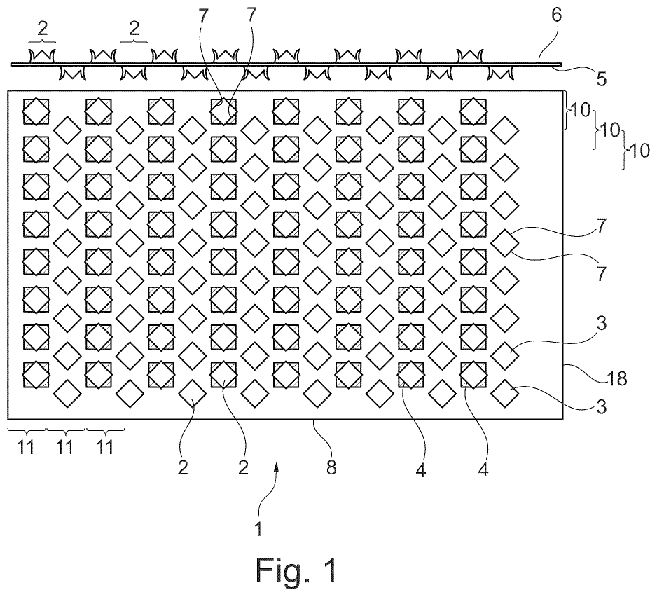

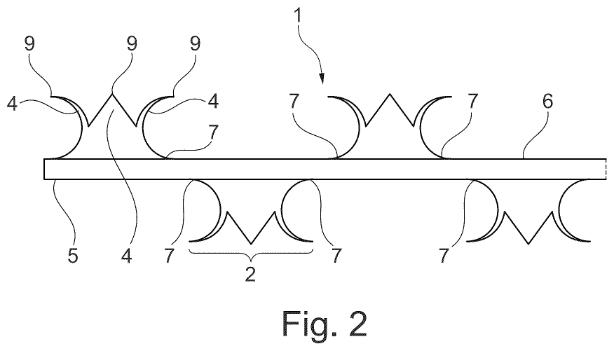

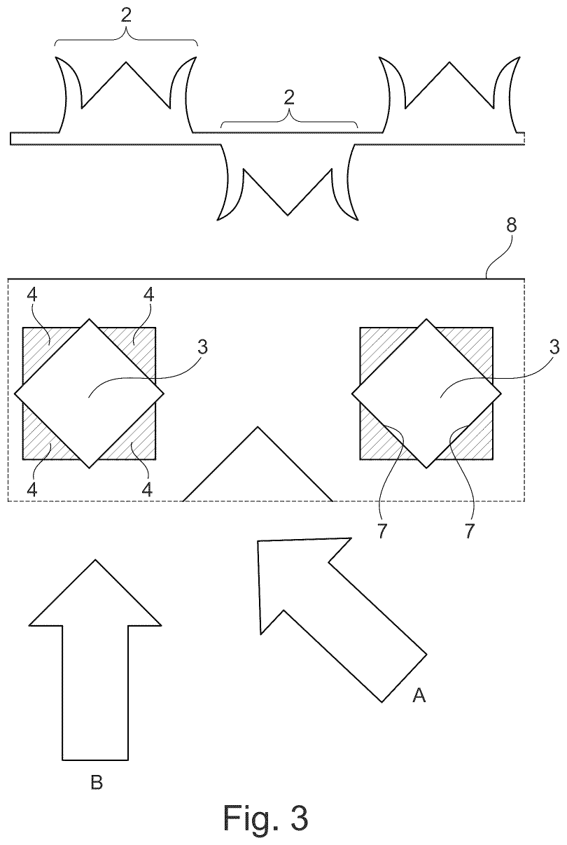

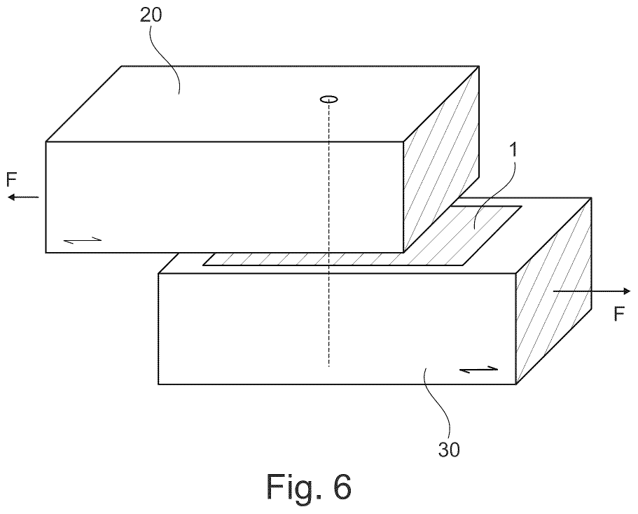

FIG. 1 shows a side view and a plan view of a sheet metal 1 according to one exemplary embodiment of the present disclosure; FIG. 2 shows an enlarged detail of the side view of FIG. 1; and FIG. 3 shows an enlarged detail of the side view and the plan view of FIG. 1. The sheet metal 1 serves for joining two wooden elements 20, 30 (see FIG. 6), the sheet metal 1 having punched structures 2 each having a hole 3 with a diameter of less than 5 mm, preferably less than 3.5 mm, more preferably less than 2.5 mm, and four teeth 4 projecting from a main surface 5, 6 of the sheet metal 1 distributed around a circumference of the hole 3. The punched structures 2 are provided on both main surfaces 5, 6 of the sheet metal 1. A number of the punched structures 2 per cm² can be between 2 and 15, preferably between 3 and 10, more preferably between 5 and 8. For example, the sheet metal 1 can have external dimensions of 50×1000 mm. A number of the punched structures 2 can then be between 1300 and 6600, preferably between 2600 and 5300, more preferably between 4000 and 4600. At least in the majority of the punched structures 2, preferably in all punched structures 2, all teeth 4 of a respective punched structure 2 project from the same main surface 5, 6 of the sheet metal 1. A number of the punched structures 2 on the one main surface 5 is at least 90%, preferably 100%, of a number of the punched structures 2 on the other main surface 6. A sheet metal thickness is less than 0.5 mm. The sheet metal 1 is configured to be screwed through by a screw. The sheet metal 1 is preferably strain hardened and the teeth 4 are hardened.

According to FIG. 1, the teeth 4 each have a base line 7 corresponding to an intersection of the respective tooth 4 with the corresponding main surface 5, 6 of the sheet metal 1 and at which the respective tooth 4 projects from the corresponding main surface 5, 6 of the sheet metal 1. An angle of the base line 7 to an edge 8 of the sheet metal 1, preferably a long edge of the sheet metal 1, is preferably between 30 and 60°, more preferably between 40 and 50°, particularly preferably substantially 45°. In the exemplary embodiment of FIG. 1, the base line 7 is substantially straight. In the case of a curved base line 7, the angle can be measured as a mean angle enclosed between the edge 8 of the sheet metal and a line connecting end points of the curved base line 7.

A total volume of all four teeth 4 of a respective punched structure 2 is less than 2.5 mm³.

According to FIG. 2, the teeth 4 are curved such that a tooth tip 9 of a respective tooth 4 faces away from the hole 3, wherein the tooth tips 9 of adjacent teeth 4 do not form a minimum distance between the adjacent teeth 4. Instead, the minimum distance between the adjacent teeth 4 can be measured between the respective base lines 7. The tooth tips 9 of a tooth 4 are curved toward the side facing away from the hole, but do not project beyond the base line 7 or beyond a tooth root. Even if the teeth 4 are curved, a distance between two adjacent teeth 4 can be greater than the diameter of the hole 3.

The curvature of the teeth 4 can be achieved by adjusting a certain punch depth of a punch in the sheet metal 1. The punch ensures the formation of the punched structures 2. The punch preferably has a rectangular profile, more preferably a square profile, in cross section. The punch can have, for example, an edge length of 1.4 mm. In this case, the sheet metal 1 can consist, for example, of an unalloyed metal and have a thickness of 0.3 mm.

According to FIG. 1, the punched structures 2 are arranged in each case in a matrix with rows 10 and columns 11 on both main surfaces 5, 6 of the sheet metal 1, wherein in each case adjacent rows 10 are displaced from one another by half a hole spacing in the longitudinal direction of the rows 10 and wherein in each case adjacent columns 11 are displaced from one another by half a hole spacing in the longitudinal direction of the columns 11. The rows 10 are oriented perpendicularly to the columns 11.

An orientation of the rows 10 and an orientation of the columns 11 are substantially parallel to a respective edge 8 of the sheet metal 1. In the exemplary embodiment of FIG. 1, the edge 8 is a longer edge of the sheet metal 1, and an edge 18 is a shorter edge of the sheet metal 1. The rows 10 run parallel to the longer edge 8 and the columns 11 run parallel to the shorter edge 18. In an alternative exemplary embodiment, the rows 10 can run parallel to the longer edge 8, and the columns 11 can run parallel to the shorter edge 18. In this alternative exemplary embodiment, the production costs of the sheet metal 1 are lower.

The matrix has first rows 10 with first punched structures 2, the teeth 4 of which project from the one main surface 5 of the sheet metal 1, and second rows 10 with second punched structures 2, the teeth 4 of which project from the other main surface 6 of the sheet metal 1, wherein the first rows 10 and the second rows 10 are arranged adjacent to one another and alternately on both main surfaces 5, 6 of the sheet metal 1.

The distances between adjacent rows 10 and the distances between adjacent columns 11 are in each case constant.

The holes 3 of a first row 10 on the first main surface 5, which is arranged adjacent to a second row 10 on the second main surface 6, are thus located substantially centrally between the holes 3 of the second row 10. At the same time, the holes 3 of a first column 11 on the first main surface 5, which is arranged adjacent to a second column 11 on the second main surface 6, are located substantially centrally between the holes 3 of the second column 11.

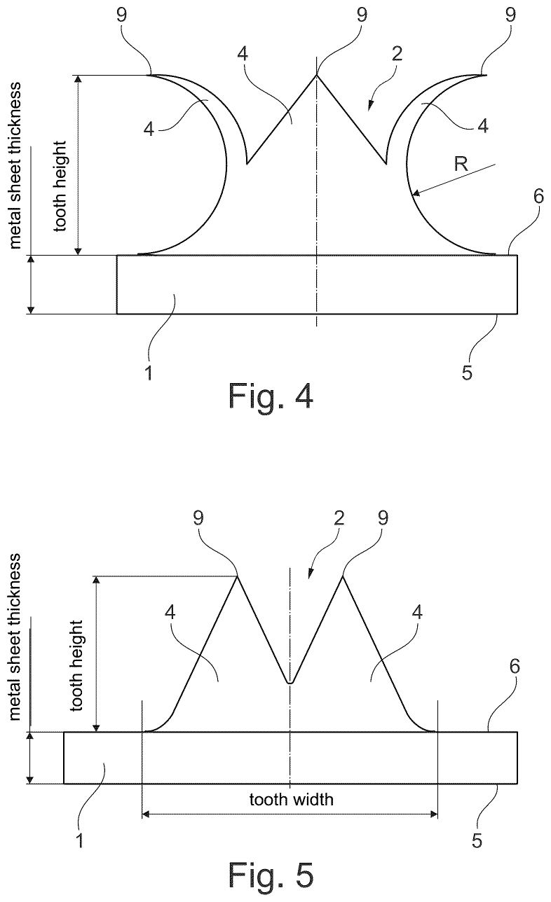

FIG. 4 shows a side view of a punched structure 2 from a direction A of FIG. 3; and FIG. 5 shows a side view of the punched structure 2 from a direction B of FIG. 3. The direction B runs substantially perpendicularly to an edge 8 of the sheet metal 1, while the direction A runs substantially at an angle of 45° to the edge 8 of the sheet metal 1. The edge 8 of the sheet metal 1 is preferably a long edge of the sheet metal. Tooth tips 9 of opposite teeth 4 of a respective punched structure 2 face in directions away from each other.

A height of the teeth 4 is 1.5 to 5 times, preferably 2 to 4 times, more preferably 2.5 to 3.5 times, greater than a thickness of the sheet metal 1.

Adjacent teeth 4 of the same punched structure 2 have a common overlap region extending vertically above the respective main surface 5, 6 of the sheet metal 1.

According to FIG. 4, the adjacent teeth 4 of the same punched structure 2 show a crown profile in a first side view A. The crown profile can have a ring with a plurality of, at least three, prongs arranged thereon. According to FIG. 5, the adjacent teeth 4 of the same punched structure 2 show a profile of two side-by-side, partially overlapping triangles in a second side view B. Instead of triangles, trapezoids can also be provided.

FIG. 6 shows an exemplary application of a sheet metal 1 according to one exemplary embodiment of the present disclosure. The sheet metal 1 is arranged between two wood elements 20, 30 to be connected. The reference sign F denotes a shearing force which the composite of the wood elements 20, 30 with the sheet metal 1 arranged in between can withstand. Experimental investigations have shown that the sheet metal 1 according to the disclosure ensures improved rigidity and an increased bearing load of the composite (i.e. via increased shearing force F, at which substantially no relative movement occurs between the wood elements 20, 30) in comparison with solutions of the prior art. In particular, displacement modulus k of the composite consisting of the two wood elements 20, 30 and the sheet metal 1 arranged in between of more than 12 N/mm*1/mm² could be achieved in the experimental investigations. The displacement modulus is defined as force/displacement, i.e. N/mm. In the case of the sheet metal 1, this variable is normalized to the area of the sheet metal 1:

$$Force / displacement * 1 / Area \text{-->} N / mm \times 1 / {mm}^{2} = N / {mm}^{3} .$$

The sheet metal 1 can be produced by a method which has a step for punching the sheet metal 1 with a punch so as to form the punched structures 2 each having the hole 3 with a diameter of less than 5 mm, preferably less than 3.5 mm, more preferably less than 2.5 mm, and four teeth 4 projecting from the main surface 5, 6 of the sheet metal 1 distributed around the circumference of the hole 3. The punched structures 2 are provided on both main surfaces 5, 6 of the sheet metal 1, and at least in the majority of the punched structures 2, preferably in all punched structures 2, all teeth 4 of a respective punched structure 2 project from the same main surface 5, 6 of the sheet metal 1. The number of the punched structures 2 on the one main surface 5 is at least 90%, preferably 100%, of a number of the punched structures 2 on the other main surface 6.

The punch can have a rectangular or square profile, wherein preferably an edge length of the punch is between 1 and 2.5 mm, more preferably between 1.2 and 1.6 mm. The defined curvature of the teeth 4 can be adjusted by using a certain punch depth of the punch (penetration depth of the punch into the sheet metal 1).

In FIG. 4, the curvature of the teeth 4 is clearly visible. The curvature of the teeth 4 can ensure an undercut, so that the teeth 4 not only apply the shearing force F to the wood elements 20, 30, but also a normal force component, i.e. a force component which acts perpendicularly to the main surfaces 5, 6 of the sheet metal 1. This ensures a certain adhesion of the sheet metal 1 to the main surfaces 5, 6 of the sheet metal 1 even without a screw.

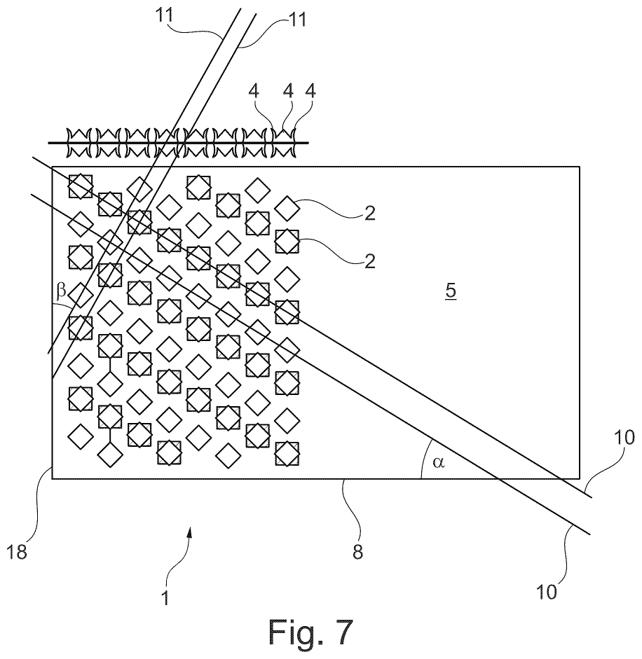

FIG. 7 shows a side view and a plan view of a sheet metal 1 according to one exemplary embodiment of the present disclosure. While in the exemplary embodiment of FIG. 1 an orientation of the rows 10 and an orientation of the columns 11 are substantially parallel to a respective edge 8 of the sheet metal 1, in the exemplary embodiment of FIG. 7 an orientation of the rows 10 and an orientation of the columns 11 run at respective angles α, β to a respective edge 8, 18 of the sheet metal 1, wherein the angles lie in a range between 30 and 60°, preferably are each substantially 45°. In addition, the punched structures 2 of a row 10 are arranged alternately on both main surfaces 5, 6 of the sheet metal 1, and the punched structures 2 of a column 11 are arranged alternately on both main surfaces 5, 6 of the sheet metal 1. A direct transmission of force between the teeth 4 of the punched structures 2 of adjacent columns 11 is thereby advantageously achieved, such that, on account of this method of production, internal stresses in the sheet metal 1 can be minimized by a more uniform distribution of the punched structures 2 and the production-related flatness of the sheet metal 1 can be optimized.

In addition, it should be noted that “comprising” does not exclude any other elements or steps and “a” or “an” does not exclude a plurality. Furthermore, it should be noted that features or steps which have been described with reference to one of the above exemplary embodiments can also be used in combination with other features or steps of other exemplary embodiments described above. Reference signs in the claims should not be regarded as a restriction.

### LIST OF REFERENCE SIGNS

1 Sheet metal
2 Punched structure
3 Hole
4 Tooth
5 the one main surface
6 the other main surface
7 base line
8 longer edge
9 tooth tip
10 row of the matrix
11 column of the matrix
18 shorter edge
20 wood element
30 wood element
A Side view
B Side view
F shearing force
α line angle
β column angle

1. A sheet metal for joining two wooden elements, the sheet metal having punched structures each having a hole with a diameter of less than 5 mm, preferably less than 3.5 mm, more preferably less than 2.5 mm, and four teeth projecting from a main surface of the sheet metal distributed around a circumference of the hole; wherein
the punched structures are provided on both main surfaces of the sheet metal;
at least in the majority of the punched structures, preferably in all punched structures, all teeth of a respective punched structure project from the same main surface of the sheet metal; and
a number of the punched structures on the one main surface is at least 90%, preferably 100%, of a number of the punched structures on the other main surface.

2. The sheet metal according to claim 1, wherein
a thickness of the sheet metal is less than 0.5 mm.

3. The sheet metal according to claim 1, wherein
the teeth each have a base line corresponding to an intersection of the respective tooth with the corresponding main surface of the sheet metal and at which the respective tooth projects from the corresponding main surface of the sheet metal;
wherein an angle of the base line to an edge of the sheet metal, preferably a long edge of the sheet metal, is preferably between 30 and 60°, more preferably between 40 and 50°, particularly preferably substantially 45°.

4. The sheet metal according to claim 3, wherein
in the case of a curved base line, the angle is measured as a mean angle enclosed between the edge of the sheet metal and a line connecting end points of the base line.

5. The sheet metal according to claim 1, wherein
a total volume of all four teeth of a respective punched structure is less than 2.5 mm³.

6. The sheet metal according to claim 1, comprising at least one of the following features:
the teeth are curved such that a tooth tip of a respective tooth faces away from the hole, and wherein the tooth tips of adjacent teeth do not form a minimum distance between the adjacent teeth;
the teeth are curved and a distance between two adjacent teeth is greater than the diameter of the hole;
the sheet metal is configured to be screwed through by a screw;
tooth tips of opposite teeth of a respective punched structure face in directions away from each other;
a height of the teeth is 1.5 to 5 times, preferably 2 to 4 times, more preferably 2.5 to 3.5 times, greater than a thickness of the sheet metal.

7. The sheet metal according to claim 1, wherein
the punched structures are arranged in each case in a matrix with rows and columns on both main surfaces of the sheet metal, wherein in each case adjacent rows are displaced from one another by half a hole spacing in the longitudinal direction of the rows and wherein in each case adjacent columns are displaced from one another by half a hole spacing in the longitudinal direction of the columns.

8. The sheet metal according to claim 7, wherein
the matrix has first rows with first punched structures, the teeth of which project from the one main surface of the sheet metal, and second rows with second punched structures, the teeth of which project from the other main surface of the sheet metal, wherein the first rows and the second rows are arranged adjacent to one another and alternately on both main surfaces of the sheet metal.

9. The sheet metal according to claim 7, wherein
an orientation of the rows and an orientation of the columns are substantially parallel to a respective edge of the sheet metal; or
an orientation of the rows and an orientation of the columns run at respective angles to a respective edge of the sheet metal, wherein the angles lie in a range between 30 and 60°, preferably are each substantially 45°.

10. The sheet metal according to claim 7, wherein
the punched structures of a row are arranged alternately on both main surfaces of the sheet metal, and/or
the punched structures of a column are arranged alternately on both main surfaces of the sheet metal.

11. The sheet metal according to claim 7, wherein
the rows run parallel to a longer edge of the sheet metal and the columns run parallel to a shorter edge of the sheet metal.

12. The sheet metal according to claim 1, wherein
adjacent teeth of the same punched structure have a common overlap region extending vertically above the respective main surface of the sheet metal.

13. The sheet metal according to claim 12, wherein
the adjacent teeth of the same punched structure show a crown profile in a first side view.

14. The sheet metal according to claim 12, wherein
the adjacent teeth of the same punched structure show a profile of two side-by-side, partially overlapping triangles or trapezoids in a second side view.

15. The sheet metal according to claim 1, wherein
the sheet metal is strain hardened and the teeth are hardened.

16. The sheet metal according to claim 1, wherein
a number of the punched structures per cm² is between 2 and 15, preferably between 3 and 10, more preferably between 5 and 8.

17. A composite of two wood elements with a sheet metal according to claim 1 arranged in between.

18. A method for producing a sheet metal for connecting two wood elements, comprising the following steps:
punching the sheet metal with a punch so as to form punched structures each having a hole with a diameter of less than 5 mm, preferably less than 3.5 mm, more preferably less than 2.5 mm, and four teeth projecting from a main surface of the sheet metal distributed around a circumference of the hole; wherein
providing the punched structures on both main surfaces of the sheet metal;
at least in the majority of the punched structures, preferably in all punched structures, all teeth of a respective punched structure project from the same main surface of the sheet metal; and
a number of the punched structures on the one main surface is at least 90%, preferably 100%, of a number of the punched structures on the other main surface.

19. The method according to claim 18, wherein
the punch has a rectangular or square profile, wherein preferably an edge length of the punch is between 1 and 2.5 mm, more preferably between 1.2 and 1.6 mm.

20. The method according to claim 18, wherein
adjusting a defined curvature of the teeth by using a certain punch depth of the punch.
